(19) United States
(12) Patent Application Publication
(10) Pub. No.: US 2025/0030179 A1
(43) Pub. Date: Jan. 23, 2025

(54) Connector

(71) Applicant: Tyco Electronics (Shanghai) Co., Ltd., Shanghai (CN)

(72) Inventors: Wenfang (Felix) Zhang, Shanghai (CN); Tongbao (Tim) Ding, Shanghai (CN); Yongjian (Justin) Huang, Shanghai (CN); Zhimin Zhang, Shanghai (CN); Chunjie Hu, Shanghai (CN)

(73) Assignee: Tyco Electronics (Shanghai) Co., Ltd., Shanghai (CN)

(21) Appl. No.: 18/778,210

(22) Filed: Jul. 19, 2024

(30) Foreign Application Priority Data
Jul. 19, 2023 (CN) 202310892229.X

(51) Int. Cl. H01R 4/18; H01R 13/422; H01R 13/428

(52) U.S. Cl. CPC H01R 4/188; H01R 13/4223; H01R 13/428

(57) ABSTRACT

A connector includes a body having a first receiving cavity, the first receiving cavity having an inner wall, and a terminal received in the first receiving cavity. The terminal has a circumferential wall that forms a channel and a first set of resilient arms disposed on the circumferential wall and extending towards the channel. The first set of resilient arms electrically contact a pin terminal inserted into the channel.

### CROSS-REFERENCE TO RELATED APPLICATION

This application claims the benefit of the filing date under 35 U.S.C. § 119(a)-(d) of Chinese Patent Application No. 202310892229.X, filed on Jul. 19, 2023.

### FIELD OF THE DISCLOSURE

The present disclosure relates to the field of electrical connection, particularly to a connector used for electrically connecting a pin terminal to a cable.

### BACKGROUND

Some connectors include terminals and bodies, such as a terminal block connector. The terminal connects to a cable. The body accommodates the terminal and enables mating between the terminal and a pin terminal.

A fixed device of a connector between the terminal and the body is limited by the structure of the terminal and the body and is single and inflexible. For example, limited by space size in different applications, a connector is applicable to an output direction of the pin terminals. Users often find it inconvenient to apply existing connectors to different application scenarios. Additionally, the insertion force required when a pin terminal plugs into the existing terminal is often relatively large. Therefore, there is need for a connector with wider applicability and a smaller insertion force that still provides a reliable electrical connection. The fixed device between the terminal and the body in such a connector should be more flexible, thereby meeting different requirements of output directions.

### SUMMARY

A connector includes a body having a first receiving cavity, the first receiving cavity having an inner wall, and a terminal received in the first receiving cavity. The terminal has a circumferential wall that forms a channel and a first set of resilient arms disposed on the circumferential wall and extending towards the channel. The first set of resilient arms electrically contact a pin terminal inserted into the channel.

### BRIEF DESCRIPTION OF THE DRAWINGS

Features, advantages and other aspects of each embodiment of the present invention will be more apparent in conjunction with the accompanying drawings and with reference to the following detailed description. Several embodiments of the present disclosure are shown herein in an illustrative and non-limiting manner. In the drawings:

FIG. 1 is a sectional perspective view of an internal structure of a connector according to an embodiment of the present disclosure;

FIG. 2 is a perspective view of an external structure of a terminal according to an embodiment of the present disclosure;

FIG. 3 is a sectional detail view of an internal structure of the terminal according to an embodiment of the present disclosure;

FIG. 4 is another perspective view of the external structure of the terminal;

FIG. 5 is a perspective view of a connection between the terminal and a pin terminal according to an embodiment of the present disclosure;

FIG. 6 is an enlarged schematic diagram of the area a in FIG. 1;

FIG. 7 is a perspective view of a body according to an embodiment of the present disclosure;

FIG. 8 is a perspective view of the connector according to an embodiment of the present disclosure;

FIG. 9 is a perspective view of the connector connecting a cable and the pin terminal according to an embodiment of the present disclosure; and

FIG. 10 is a perspective view of the terminal of the connector connecting the cable and the pin terminal according to an embodiment.

### DETAILED DESCRIPTION

The present disclosure is described in detail below through embodiments and in conjunction with the accompanying drawings. The same or similar reference numerals throughout the description indicate the same or similar components. The following description of the embodiments of the present disclosure with reference to the accompanying drawings is intended to explain the overall inventive concept of the present disclosure and should not be construed as a limitation to the present disclosure.

The terms “includes”, “comprises” and the like used in the present disclosure should be interpreted as open-ended terms, i.e., “includes/comprises but is not limited to”, indicating that other elements may also be included. The term “based on” indicates “at least partly based on”. The term “one embodiment” indicates “at least one embodiment”. The term “another embodiment” indicates “at least one additional embodiment”, and so on.

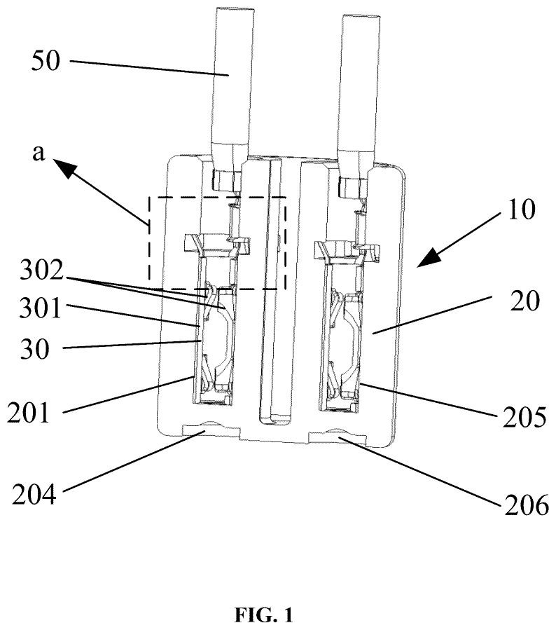

FIG. 1 shows a schematic diagram of an internal structure of a connector according to an embodiment of the present disclosure. The connector 10 includes a body 20 and a terminal 30. In an embodiment, the body 20 can be made of plastic, and the terminal 30 can be made of copper alloys such as brass or phosphor bronze.

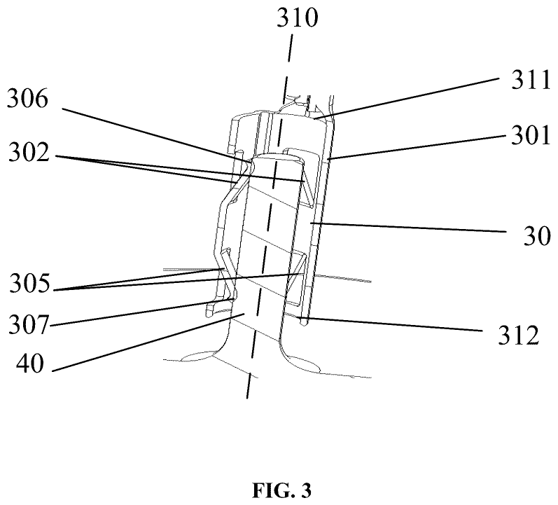

As shown in FIG. 1, the body 20 has a first receiving cavity 201 with a circumferential inner wall. The terminal 30 is received in the first receiving cavity 201. The terminal 30 includes a circumferential wall 301 and a first set of resilient arms 302. The circumferential wall 301 forms a channel. The first set of resilient arms 302 is disposed on the circumferential wall 301 and extends towards the channel, such as to electrically contact with a pin terminal inserted into the channel. In the shown embodiment, an external structure of the terminal 30 is approximately cylindrical, and the first receiving cavity 201 that receives the terminal 30 also has an approximately cylindrical inner cavity; thus, the terminal 30 can be relatively flexibly fixed within the first receiving cavity 201, enabling the terminal 30 to rotate about the axial direction 310 of the circumferential wall 301 (shown in FIG. 3) in the first receiving cavity 201.

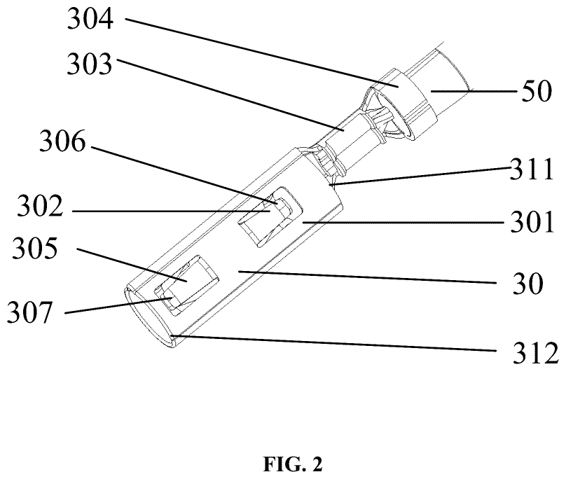

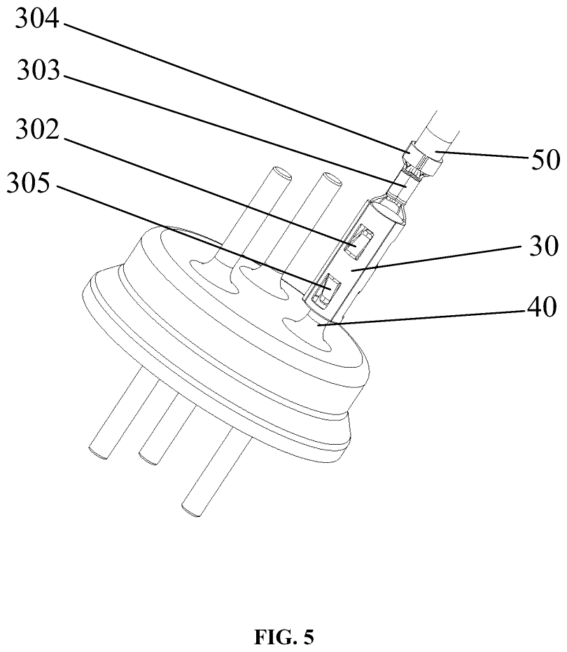

As shown in FIGS. 2 and 5, the terminal 30 further includes a crimping portion. The crimping portion is located at a first end 311 of the circumferential wall 301 and is used for crimping a cable 50. In the shown embodiment, the crimping portion includes a first crimping portion 303 and a second crimping portion 304, both of which consist of U-shaped bases and wings extending from both sides of the U-shaped bases. After stripping the outer insulated layer of the cable 50, the exposed conductive wire core is placed inside the U-shaped base, and the wings of the first crimping portion 303 and the second crimping portion 304 are bent for contact and fixation, thus achieving a reliable electrical connection between the cable 50 and the crimping portion.

As shown in FIGS. 2 and 3, the terminal 30 further includes a second set of resilient arms 305. The second set of resilient arms 305 is disposed on the circumferential wall 301 and extends towards the channel, wherein the second set of resilient arms 305 is distributed along the axial direction 310 of the circumferential wall 301 relative to the first set of resilient arms 302.

The pin terminal 40, shown in FIG. 5, further electrically contacts with the second set of resilient arms 305 when inserted into the channel. In other words, in the process of entering the channel, the pin terminal 40 matches and contacts with the second set of resilient arms 305 and the first set of resilient arms 302 successively, which not only ensures the electrical connection between the terminal 30 and the pin terminal 40, but also reduces the insertion force required for the terminal 30 to make it more convenient for users.

The first set of resilient arms 302 and the second set of resilient arms 305 can be formed by bending the portions cut from the circumferential wall 301. In this embodiment, the first set of resilient arms 302 includes three resilient arms, and the second set of resilient arms 305 includes three resilient arms. The arrangement of multiple resilient arms can provide multiple contact points for the electrical connection of the terminal 30, which contributes to the stability of the contact and is more suitable for high-current transmission. In other examples, the first set of resilient arms 302 can include more than three resilient arms, and the second set of resilient arms 305 can also include more than three resilient arms.

As shown in FIG. 3, the circumferential wall 301 also includes a second end 312 opposite to the first end 311. The first set of resilient arms 302 is closer to the first end 311 than the second set of resilient arms 305. The first set of resilient arms 302 also extends towards the first end 311, and the second set of resilient arms 305 also extends towards the second end 312.

When the pin terminal 40 is inserted into the channel of the terminal 30, the pin terminal 40 first contacts with the second set of resilient arms 305. Since the extending direction of the second set of resilient arms 305 is partially opposite to the inserted direction of the pin terminal 40, and the second set of resilient arms 305 extends at a certain angle within the channel, the second set of resilient arms 305 can restrict the inserted angle of the pin terminal 40, preventing it from being inserted obliquely. With the pin terminal 40 further inserted, it contacts with the first set of resilient arms 302. Since the extending direction of the first set of resilient arms 302 is partially the same as the inserted direction of the pin terminal 40, it is easy for the pin terminal 40 to match and contact with the first set of resilient arms 302, thus ensuring the effectiveness of the electrical connection.

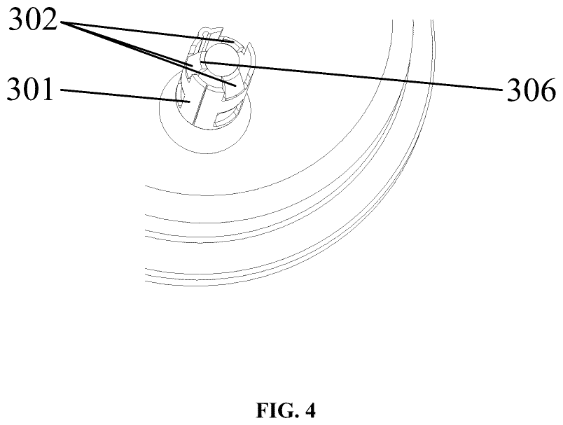

As shown in FIGS. 2, 3, and 4, each resilient arm of the first set of resilient arms 302 includes a first guiding portion 306 disposed at the free end thereof. The first guiding portions 306 are distributed parallel to the axial direction 310 and distributed around it. Each resilient arm of the second set of resilient arms 305 includes a second guiding portion 307 disposed at the free end thereof. The second guiding portions 307 are also distributed parallel to the axial direction 310 and distributed around it. The first guiding portions 306 and the second guiding portions 307 provide contact points between the terminal 30 and the pin terminal 40, which can guide the pin terminal 40 to be inserted forward within the channel. In this embodiment, considering that the cross-section of the pin terminal 40 is circular, to increase the contact area between the resilient arms 302 and the pin terminal 40, the guiding portions of the resilient arms 302 are arranged with curved surfaces to fit against the pin terminal 40. In other examples, the guiding portions can also be arranged with flat contact surfaces for simplicity in manufacturing.

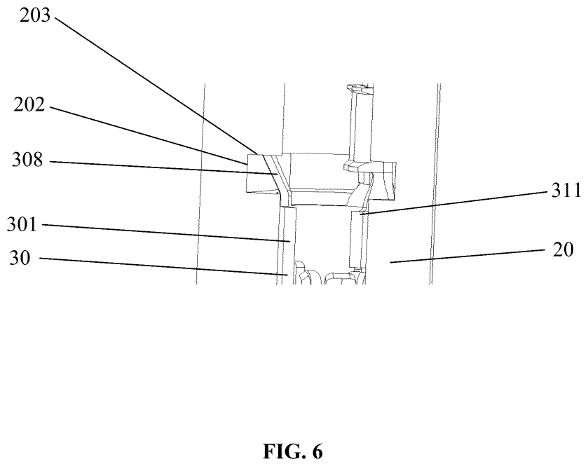

FIG. 6 shows an enlarged schematic view of the area a in FIG. 1. As shown in FIGS. 1 and 6, the terminal 30 also includes a locking portion 308. The locking portion 308, which is disposed on the circumferential wall 301, extends away from the circumferential wall 301 and towards the direction from the second end 312 to the first end 311. The locking portion 308 is used to lock the terminal 30 in the body 20. The locking portion 308 can be a resilient element of which the other end is a free end. During the process of inserting the terminal 30 into the body 20, the free end of the locking portion 308 needs to be retracted inward. As the terminal 30 is inserted downwards into the first receiving cavity 201 of the body 20, the locking portion 308 of the terminal 30 will automatically open and be seated within a first locking cavity 202 of the body 20, thereby preventing the terminal 30 from being withdrawn from the body 20.

As shown in FIG. 6, the body 20 includes the first locking cavity 202. The first locking cavity 202 has a circumferential end wall 203 and is configured to receive the locking portion 308 of the terminal 30 to lock the terminal 30 in the body 20, wherein the radius of the end wall 203 of the first locking cavity 202 is greater than the radius of the circumferential inner wall of the first receiving cavity 201. When the terminal 30 enters into the body 20, the locking portion 308 of the terminal 30 opens and abuts against the end wall 203 of the first locking cavity 202, securing the terminal 30 in the body 20. In this embodiment, the first locking cavity 202 is a cylindrical slot. However, in other examples, the first locking cavity 202 may be a slot of different shapes.

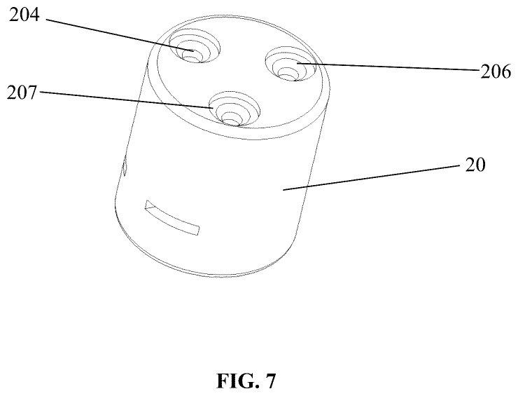

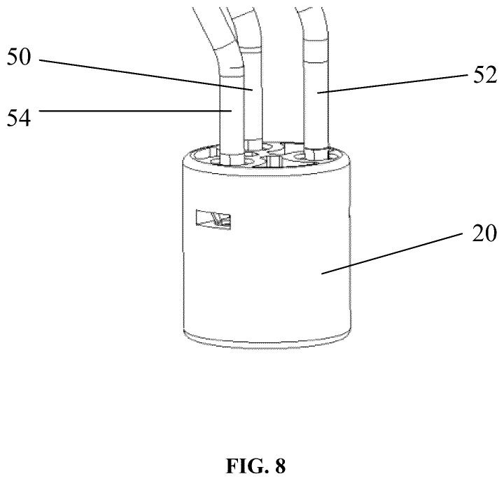

As shown in FIGS. 1, 7, and 8, the body 20 further includes a first insertion hole 204, which extends through the surface of the body 20 and communicates with the first receiving cavity 201. The first insertion hole 204 allows the pin terminal 40 to pass through and then to be inserted into the channel of the terminal 30, such that the pin terminal 40 is in electrical contact with the terminal 30. Optionally, the body also includes a second accommodation cavity 205 and a second insertion hole 206. The second receiving cavity 205 has a circumferential inner wall and is configured to accommodate another terminal. The second insertion hole 206 extends through the surface of the body 20 and communicates with the second receiving cavity 205. In other embodiments, the body 20 may have any numbers of receiving cavities and insertion holes, to accommodate any numbers of terminals and enable the terminals to be plugged with the corresponding pin terminals. In this embodiment, the body 20 also includes a third receiving cavity and a third insertion hole 207. The third receiving cavity has a circumferential inner wall and is configured to accommodate another terminal. The third insertion hole 207 extends through the surface of the body 20 and communicates with the third receiving cavity.

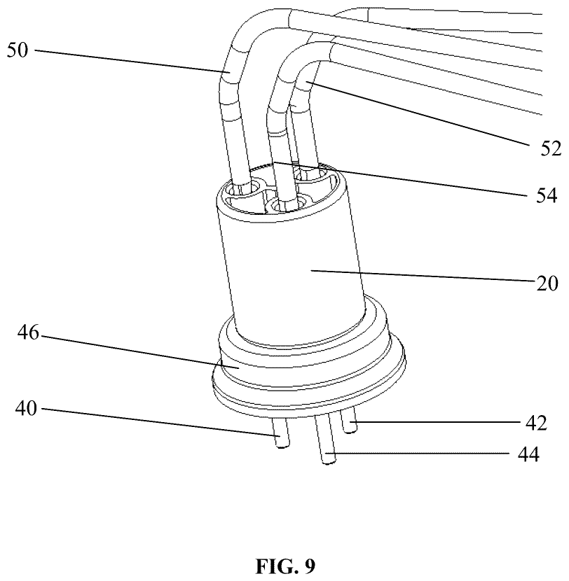

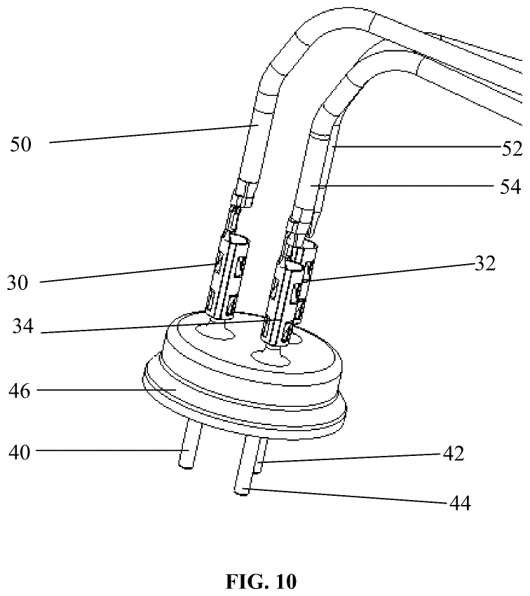

As shown in FIGS. 9 and 10, the connector 10 in this embodiment includes the first terminal 30, a second terminal 32, and a third terminal 34, which connect to one ends of the cable 50, a second cable 52, and a third cable 54 respectively. The body 20 of the connector 10 includes the first receiving cavity 201, the second receiving cavity 205, the third receiving cavity, the first insertion hole 204, the second insertion hole 206, and the third insertion hole 207. The first receiving cavity 201, the second receiving cavity 205, and the third receiving cavity accommodate the first terminal 30, the second terminal 32, and the third terminal 34, respectively. When a conductive connecting component 46 is installed on the connector 10, the first pin terminal 40 passes through the first insertion hole 204 and then contacts with the resilient arms of the first terminal 30 to form an electrical connection; the second pin terminal 42 passes through the second insertion hole 206 and then contacts with the resilient arms of the second terminal 32 to form an electrical connection; and the third pin terminal 44 passes through the third insertion hole 207 and then contacts with the resilient arms of the third terminal 34 to form an electrical connection. This allows one ends of the cables 50, 52, and 54 to form electrical connections with one ends of the first pin terminal 40, the second pin terminal 42, and the third pin terminal 44 of the conductive connecting component 46 via the first terminal 30, the second terminal 32, and the third terminal 34, respectively. At the same time, the other ends of the cables 50, 52, and 54 are connected to a power supply, while the other ends of the first pin terminal 40, the second pin terminal 42, and the third pin terminal 44 come from an air compressor, thus enabling the cables to provide power to the air compressor.

In practical application scenarios, the structure of the conductive connecting component is set and the electrical signal to which its pin terminal corresponds is usually predetermined and difficult to change. Additionally, the location of the cables and the electrical signals connected to the cables respectively are often pre-set. The connector proposed in the present disclosure provides higher flexibility for the electrical connection between the conductive connecting component and the cable. Specifically, when the terminals that connect cables are installed in the body, because both the terminal and the receiving cavity are cylindrical, the terminals can rotate within the receiving cavities to adapt to disposition and orientation of the cables. In an embodiment, the body of the connector is cylindrical, allowing itself to rotate around its axis to change the orientation of the cables before it is installed on the conductive connecting component. This connector can be adapted to different output directions of the conductive connecting component under various application scenarios, satisfying the requirements for signal transmission between the conductive connecting components and the cables.

It should be understood that the above embodiments are illustrative to the connector under the exemplary application scenario of an air compressor. The connector described above can be applied to other suitable scenarios where electrical connections are required.

The description above merely contains exemplary embodiments of the present invention. Through this description, as well as the accompanying drawings and claims, a person skilled in the art will readily realize that various changes, modifications, and variations can be made to the present invention without departing from the spirit and scope of the invention defined by the appended claims.

What is claimed is:

1. A connector, comprising:
a body having a first receiving cavity, the first receiving cavity having an inner wall; and
a terminal received in the first receiving cavity, the terminal including a circumferential wall that forms a channel and a first set of resilient arms disposed on the circumferential wall and extending towards the channel, the first set of resilient arms electrically contact a pin terminal inserted into the channel.

2. The connector according to claim 1, wherein the terminal rotates about an axial direction of the circumferential wall in the first receiving cavity.

3. The connector according to claim 1, wherein the terminal includes a crimping portion at a first end of the circumferential wall that crimps to a cable.

4. The connector according to claim 3, wherein the terminal includes a second set of resilient arms disposed on the circumferential wall and extending towards the channel.

5. The connector according to claim 4, wherein the second set of resilient arms is distributed along an axial direction of the circumferential wall relative to the first set of resilient arms.

6. The connector according to claim 5, wherein the pin terminal further electrically contacts the second set of resilient arms when inserted into the channel.

7. The connector according to claim 6, wherein the first set of resilient arms includes at least three resilient arms and the second set of resilient arms includes at least three resilient arms.

8. The connector according to claim 6, wherein the circumferential wall has a second end opposite to the first end, the first set of resilient arms are closer to the first end than the second set of resilient arms.

9. The connector according to claim 8, wherein the first set of resilient arms extend toward the first end and the second set of resilient arms further extend toward the second end.

10. The connector according to claim 6, wherein each resilient arm of the first set of resilient arms includes a first guiding portion disposed at a free end thereof, the first guiding portions of the first set of resilient arms are distributed parallel to and around the axial direction.

11. The connector according to claim 10, wherein each resilient arm of the second set of resilient arms includes a second guiding portion disposed at a free end thereof, the second guiding portions of the second set of resilient arms are distributed parallel to and around the axial direction.

12. The connector according to claim 9, wherein the terminal includes a locking portion disposed on the circumferential wall.

13. The connector according to claim 12, wherein the locking portion extends away from the circumferential wall and towards a direction from the second end to the first end, the locking portion locks the terminal in the body.

14. The connector according to claim 12, wherein the body includes a first insertion hole that extends through a surface of the body and communicates with the first receiving cavity.

15. The connector according to claim 14, wherein the body includes a first locking cavity having a end wall, the first locking cavity receives the locking portion of the terminal to lock the terminal in the body.

16. The connector according to claim 15, wherein a radius of the end wall of the first locking cavity is greater than a radius of the inner wall of the first receiving cavity.

17. The connector according to claim 15, wherein the body includes a second receiving cavity having an inner wall that accommodates another terminal.

18. The connector according to claim 17, wherein the body includes a second insertion hole that extends through the surface of the body and communicates with the second receiving cavity.
